(19) United States
(12) Patent Application Publication
(10) Pub. No.: US 2024/0240511 A1
(43) Pub. Date: Jul. 18, 2024

(54) SLIDING POCKET DOOR SOUND ATTENUATION SYSTEM

(71) Applicant: Randall Klassen, Winnipeg (CA)

(72) Inventor: Randall Klassen, Winnipeg (CA)

(21) Appl. No.: 18/180,256

(22) Filed: Mar. 8, 2023

Related U.S. Application Data
(60) Provisional application No. 63/439,192, filed on Jan. 16, 2023.

(51) Int. Cl. E06B 5/20; E05D 15/06

(52) U.S. Cl. CPC E06B 5/20; E05D 15/0652

(57) ABSTRACT

The sound attenuation system operates within a cavity in a wall adjacent a door opening relative to which to the sliding door operates in which the cavity receives the sliding pocket door therein when the door is opened. The system includes a collapsible material, whether it be accordion-style/retractable or other, which can unfold/unroll to fill a void left by a closed pocket door and fold up/roll up into a compact space within the door pocket when the door is opened. The collapsible device is mechanically fastened between the door and wall framing said door opens to, thereby allowing the collapsible device to open within the wall as the pocket door is closed. The system may also include a stiff sound absorbing material supported within the pocket door framing that defines the door pocket without interference to the sliding of the pocket door.

This application claims the benefit under 35 U.S.C.119(e) of U.S. provisional application Ser. No. 63/439,192, filed Jan. 16, 2023.

### FIELD OF THE INVENTION

The present invention relates to a sound attenuation system for use with a sliding pocket door assembly in which a sliding door is received in a door pocket within a wall cavity adjacent a door opening when the sliding door is opened, and more particularly the present invention relates to a sound attenuation system that for attenuating sound within the wall cavity adjacent the door opening when the door is closed.

### BACKGROUND

Unwanted noise leaking through doors and windows can be frustrating to deal with when trying to sleep, work, or relax. Lack of privacy and concentration can lead to decreased productivity throughout the day. If a person is unable to sleep due to outside noise, they could become stressed and anxiety ridden. Accordingly, various attempts have been made to insulate wall cavities or the hollow core of a door panel with sound attenuating materials to minimize transmission of sound through walls and doors; however, known sound attenuating materials are not well suited for use with a sliding pocket door assembly in which a sliding door is opened and closed relative to a door opening in a wall by sliding the door into and out or a door pocket in the wall beside the door opening. The placement of traditional sound attenuating materials within the door pocket to minimize transmission of sound through the wall at the location of the door pocket would interfere with the proper functioning of the sliding door assembly to be slidably displaced into and out of the door pocket as the sliding door assembly is opening and closed.

### SUMMARY OF THE INVENTION

According to one aspect of the invention there is provided a sound attenuation system for a sliding pocket door assembly operable relative to a door opening in a wall, the sliding pocket door assembly including (i) a sliding door member extending in a longitudinal direction between opposing upright side edges of the sliding door member, (ii) a track arranged to support the sliding door member thereon such that the sliding door member is slidable along the track in the longitudinal direction of the sliding door member relative to the door opening between a closed position spanning across the door opening and an open position in which the door opening is substantially unobstructed by the sliding door member, and (iii) a pocket door frame arranged to be mounted in the wall adjacent to the door opening and defining a door pocket therein for receiving the sliding door member in the open position of the sliding door member in which the pocket door frame includes first and second side frames extending longitudinally along opposing sides of the door pocket respectively to receive the sliding door member between the first and second side frames respectively, the sound attenuating system comprising:
a sound attenuating structure arranged to be supported within the door pocket to span a width of the door pocket in the longitudinal direction of the sliding pocket door assembly from a first end to a second end of the sound attenuating structure when the sliding door member is in the closed position in which the sound attenuating structure is formed of a sound absorbing material;
a first mounting arrangement arranged to secure the first end of the sound attenuating structure to an inner end of the door pocket farthest from the door opening;
a second mounting arrangement arranged to secure the second end of the sound attenuating structure to the sliding door member such that the second end of the sound attenuating structure is movable with the sliding door member between the open position and the closed position of the sliding door member;
wherein the sound attenuating structure is collapsible in length in the longitudinal direction of the sliding door member between the first mounting arrangement and the second mounting arrangement responsive to displacement of the sliding door member from the closed position to the open position.

According to a second aspect of the present invention there is provided a sliding pocket door assembly for operation relative to a door opening in a wall, the sliding pocket door assembly comprising:
a sliding door member extending in a longitudinal direction between opposing upright side edges of the sliding door member;
a track arranged to support the sliding door member thereon such that the sliding door member is slidable along the track in the longitudinal direction of the sliding door member relative to the door opening between a closed position spanning across the door opening and an open position in which the door opening is substantially unobstructed by the sliding door member;
a pocket door frame arranged to be mounted in the wall adjacent to the door opening and defining a door pocket therein for receiving the sliding door member in the open position of the sliding door member in which the pocket door frame includes first and second side frames extending longitudinally along opposing sides of the door pocket respectively to receive the sliding door member between the first and second side frames respectively;
a sound attenuating structure supported within the door pocket to span a width of the door pocket in the longitudinal direction of the sliding pocket door assembly from a first end to a second end of the sound attenuating structure when the sliding door member is in the closed position in which the sound attenuating structure is formed of a sound absorbing material;
a first mounting arrangement securing the first end of the sound attenuating structure to an inner end of the door pocket farthest from the door opening; and
a second mounting arrangement securing the second end of the sound attenuating structure to the sliding door member such that the second end of the sound attenuating structure is movable with the sliding door member between the open position and the closed position of the sliding door member;
wherein the sound attenuating structure is collapsible in length in the longitudinal direction of the sliding door member between the first mounting arrangement and the second mounting arrangement responsive to displacement of the sliding door member from the closed position to the open position.

The collapsibility of the sound attenuating structure to reduce in length responsive to displacement of the sliding door member between open and closed positions allows the sound attenuating structure to be supported within a door pocket in a wall that receives a sliding door therein to attenuate sound when the door is closed without interfering with the movement of the door from the close position to the open position. The sound attenuating system described herein provides users with a material installed within pocket doors to help reduce noise transmission through the door. The system can be used to fill the pocket door void via an accordion-style structure or a roll-up structure, installed on the vertical side of the door as well as on the existing wall framing. The system can be installed on any type of door with a sliding motion to operate, functioning as a hidden source of sound reduction whereby the system improves privacy for people who want to relax at any hour of the day.

Preferably the sound attenuating structure is collapsible to a collapsed position having a length in the longitudinal direction between the first end and the second end of sound attenuating structure that is sized to be received within the door pocket longitudinally end-to-end with the sliding door member in the open position of the sliding door member.

The sliding pocket door assembly may comprise a stop member supported within the door pocket to engage one of the upright side edges of the sliding door member in the open position of the sliding door member in which the stop member is spaced from an inner terminal end of the door pocket towards the door opening at a prescribed distance. In this instance, the length of the sound attenuating structure in the collapsed position is preferably equal to or less than said prescribed distance.

Preferably the second mounting arrangement secures the second end of the sound attenuating structure to one of the upright side edges of the sliding door member that is received within the door pocket in the closed position of the sliding door member.

The sound attenuating system may further include at least one sound attenuating panel arranged to be fixedly supported on at least one of the side frames of the pocket door frame so as to receive the sliding door member in the door pocket alongside said at least one sound attenuating panel in the open position of the sliding door member.

Preferably said at least one sound attenuating panel comprises a rigid panel of sound attenuating material fully received within a boundary of said at least one of the side frames of the pocket door frame.

The at least one sound attenuating panel may span a full thickness of said at least one of the side frames of the pocket door frame in a direction perpendicular to the sliding door member.

The at least one sound attenuating panel may further include adhesive flaps mounted along one or more edges of said at least one sound attenuating panel so as to be arranged to adhesively secure said at least one sound attenuating panel to said at least one of the side frames of the pocket door frame.

According to one embodiment, the sound attenuating structure comprises a sheet having a plurality of accordion pleats formed therein such that the sound attenuating structure is arranged to be collapsed in the longitudinal direction by folding the according pleats.

According to a second embodiment, one of the first mounting arrangement and the second mounting arrangement comprises a roller and the sound attenuating structure comprises a flexible sheet mounted along one upright edge onto the roller such that the sound attenuating structure is arranged to be collapsed in the longitudinal direction by rolling up the sheet onto the roller, in which the roller is biased in a direction to roll up the sheet onto the roller.

### BRIEF DESCRIPTION OF THE DRAWINGS

Some embodiments of the invention will now be described in conjunction with the accompanying drawings in which:

FIG. 1 is a perspective view of a first embodiment of the sound attenuation system according to the present invention shown supported on a sliding pocket door assembly in a closed position in which some of the sound attenuating panels have been removed for illustrative purposes;

FIG. 2 is a side elevational view of the sound attenuation system according to the first embodiment of FIG. 1 in an open position of the sliding pocket door assembly;

FIG. 3 is a perspective view of a first mounting arrangement of the sound attenuation system according to the first embodiment of FIG. 1;

FIG. 4 is a sectional view along the line 4-4 in FIG. 2 in an open position of the sliding pocket door assembly;

FIG. 5 is a sectional view along the line 4-4 in FIG. 2 in a closed position of the sliding pocket door assembly;

FIG. 6 is a side elevational view of the sound attenuation system according to a second embodiment in an open position of the sliding pocket door assembly;

FIG. 7 is a sectional view along the line 7-7 in FIG. 6 in an open position of the sliding pocket door assembly; and

FIG. 8 is a sectional view along the line 7-7 in FIG. 6 in a closed position of the sliding pocket door assembly.

In the drawings like characters of reference indicate corresponding parts in the different figures.

### DETAILED DESCRIPTION

Referring to the accompanying figures, there is illustrated a sound attenuation sliding pocket door assembly generally indicated by reference numeral 10. The pocket door assembly incorporates a sound attenuation system for attenuating sound in the void left within the door pocket 12 of the sliding pocket door assembly when the sliding door member 14 of the assembly is slidably removed from the door pocket 12 for closing the sliding door member across an adjacent door opening 16 within a wall 18.

The pocket door assembly 10 generally includes a pocket door frame 20 which is mounted internally within the wall 18, for example the wall of a building, vehicle and the like at a location adjacent to the door opening 16 in the wall so as to define the door pocket 12 of the assembly internally within the pocket door frame 20 adjacent to the door opening. In this manner the sliding door member 14 can be operated for longitudinal sliding movement parallel to the wall 18 in a longitudinal direction relative to the door opening 16 from a closed position in which the sliding door member 14 fully spans across the door opening and an open position in which the door opening is partly or fully unobstructed by the sliding door member by slidably displacing the door member 14 longitudinally into the door pocket within the pocket door frame.

The pocket door frame 20 includes a header 22 mounted within the wall 18 to define the top end of the door opening 16 and the top end of the adjacent door pocket 12. More particularly, the header 22 extends continuously from the door opening into the door pocket and supports a track 24 thereon upon which the door member 14 is supported for longitudinal sliding movement between the open and closed positions thereof. The sliding door member 14 is a rigid panel of material spanning a height of the door opening in the closed position and spanning in a longitudinal direction between opposing upright side edges of the door member to define a length in the longitudinal direction that is equal to or greater than the corresponding dimension of the door opening 16.

The sliding door member 14 is mounted on a set of followers 26 at longitudinally spaced positions across the top edge of the panel forming the sliding door member 14. The followers 26 cooperate with the track 24 to suspend the sliding door member from the track while supporting the sliding door member for longitudinal sliding movement by displacing the followers 26 within the track 24, for example by the use of rollers or sliding bushings and the like.

The pocket door frame 20 further includes a first side frame 28 and a second side frame 30 spanning the width of the door pocket in the longitudinal direction and spanning the full height of the door pocket between a floor and the header 22. The first and second side frames 28 and 30 are spaced apart from one another to define a thickness of the door pocket 12 in a direction perpendicular to a plane of the door member 14. Each side frame comprises a set of framing studs 32 which extend vertically between the floor and the header at longitudinally spaced positions. Each stud 32 also occupies a full thickness of the respective side frame 28 or 30 without protruding into the gap between the side frames that defines the door pocket 12. Each side frame further includes one or more cavities defined between the studs 32 that span the height of the side frames corresponding approximately to the height of the door pocket.

In some instances, each side frame may include a respective footer (not shown) which is fully contained within the thickness of the side frame so as not to protrude into the door pocket between the side frames. In this manner the rigid panel forming the sliding door member 14 can be suspended from the track to lie in close proximity to the floor while enabling the door to be slidably received in the door pocket 12 without interference.

An inner end stud 34 is mounted within the pocket door frame 20 to span the full thickness of the pocket door frame at the inner terminal end of the door pocket farthest from the door opening. The inner end stud thus spans the combined thickness of both the first and second side frames 28 and 30 together with the thickness of the door pocket 12 between the side frames.

An outer end of the door pocket remains open between the first and second side frames 28 and 30 along the full height of the door pocket to allow open communication between the door pocket 12 and the adjacent door opening 16 through which the sliding door member 14 can be received as it is displaced between open and closed positions.

A stop member 36 is supported on the header 22 at the inner end of the track 24 to span a longitudinal distance between the end of the track and the inner terminal end of the door pocket defined by the inner end stud 34. The stop member 36 includes an outer end face 38 at the inner end of the track which is arranged to be engaged by the followers 26 or the inner end of the rigid panel forming the sliding door member 14 in the open position of the door member 14. In this manner the stop member 36 prevents movement of the sliding door member 14 in the opening direction from the closed position towards the open position beyond the open position when the sliding door member engages the stop member. In the open position of the sliding door member, the stop member 36 holds the inner upright edge of the sliding door member 14 spaced from the inner terminal end of the door pocket defined by the inner end stud 34 at a prescribed space to accommodate a collapsible portion of the sound attenuation system in the open position of the sliding door member 14 as described in further detail below.

The sound attenuation system according to the present invention functions to attenuate sound within the door pocket 12 of the sliding door assembly, particularly when the sliding door member 14 is closed and the door pocket is largely an empty cavity devoid of the sliding door member. The sound attenuation system generally comprises (i) a collapsible sound attenuation structure 40 formed of a sound attenuating material which extends vertically a height of the door pocket and extends a length of the door pocket in the longitudinal direction between a first end 42 and a second end 44 of the structure in the closed position of the sliding door member, (ii) a first mounting arrangement 46 at the first end of the structure for securing the first end to the inner end stud 34 at the inner end of the door pocket, and (iii) a second mounting arrangement 48 at the second end of the structure for securing the second end to the inner upright edge at the inner end of the sliding door member 14 that is nearest to the inner end stud 34 at the inner terminal end of the door pocket. The sound attenuation system may further include one or more sound attenuating panels 50 which are mounted in fixed relation to the pocket door frame 20 as described in further detail below.

The collapsible sound attenuation structure 40 is formed of flexible materials for example sheet material which is flexible so as to enable the structure 40 to vary in length between the first end 42 and the second end 44 thereof in the longitudinal direction responsive to movement of the sliding door member between the open and closed positions. In the illustrated embodiment, the structure 40 is able to increase in length from the open position of the sliding door member to the closed position of the sliding door member by an order of four or five times the collapsed length to span the full length of the door pocket 12 when the sliding door member is closed. In the collapsed position of the structure 40 corresponding to the open position of the door, the structure 40 is collapsed such that the overall length in the longitudinal direction between the first end and the second end is equal to or less than the length in the longitudinal direction of the prescribed space at the inner terminal end of the door pocket defined by the stop member 36.

Possible materials for construction of the collapsible structure may include, but is not limited too tightly woven cotton or other fabric, recycled paper or other recyclables, foil underlayment, fiberglass, rockwool, polyurethane foam, melamine foam, polyester wool, glass wool, and more. Exact size, measurement, construction, and design specifications may vary according to the particular sliding door assembly to which the structure is applied.

In the illustrated embodiments, the first mounting arrangement 46 includes a first strip 52 of the sound attenuating material spanning a full height of the structure at the first end thereof and which is arranged to be mounted relative to the pocket door frame 20 by various means including a row of vertically spaced apart fasteners received through the strip 52, an adhesive layer for bonding the strip 52 relative to the pocket door frame, or various hardware including clamping structures and the like which are in turn fastened or secured to the pocket door frame for securing the first strip 52 in position relative to the pocket door frame.

The second mounting arrangement 48 similarly includes a second strip 54 of the sound attenuating material spanning a full height of the structure at the second and thereof and which is arranged to be mounted relative to the inner end of the sliding door member 14 by various means including a row of vertically spaced apart fasteners received through the second strip 54, an adhesive layer for bonding the second strip 54 relative to the sliding door member, or various hardware including clamping structures and the like which are in turn fastened to the sliding door member for securing the second strip 54 in position relative to the sliding door member.

The sound attenuating panels 50 comprise rigid foam block material which is cut to size to fit within the cavities formed in the first side frame 28 and the second side frame 30 of the pocket door frame respectively. More particularly, the sound attenuating panels 50 are mounted in the cavities formed between the studs 32 so that the panels fully occupy the cavities in the side frames of the pocket door frame while also being fully contained within a boundary of each cavity defined by the studs such that the panels 50 do not protrude into the space of the door pocket 12 defined between the first and second side frames along the full height and full length in the longitudinal direction. Preferably, the panels 50 occupy the full thickness of the side frames in a direction perpendicular to the sliding door member and to the longitudinal direction such that inner side surfaces of the panels 50 are substantially flush with the inner side surfaces of the corresponding studs within the same side frames. In this manner the inner side surface of each side frame forming a respective side boundary of the door pocket comprises a smooth continuous surface devoid of any catches or protrusions that may interfere with collapsing and extension of the sound attenuating structure 40 between the open and closed positions of the sliding door member.

In the illustrated embodiment, a plurality of mounting flaps 56 are mounted at laterally opposing side edges of each panel 50 in which each mounting flap 56 comprises a flat strip of flexible material spanning a full height of the respective panel within a common plane with one of the major side faces of the panel. The flap 56 includes an adhesive layer thereon and a peelable layer covering the adhesive such that the peelable layer can be readily removed to expose the adhesive layer and permit the adhesive layer to be bonded to a corresponding surface of the adjacent studs 32 or 34 forming the boundaries of the cavities within the side frames of the pocket door frame respectively. In other embodiments, various forms of fasteners, mounting brackets or adhesive tape can be used to secure the panels 50 within the respective cavities in the pocket door frame 20.

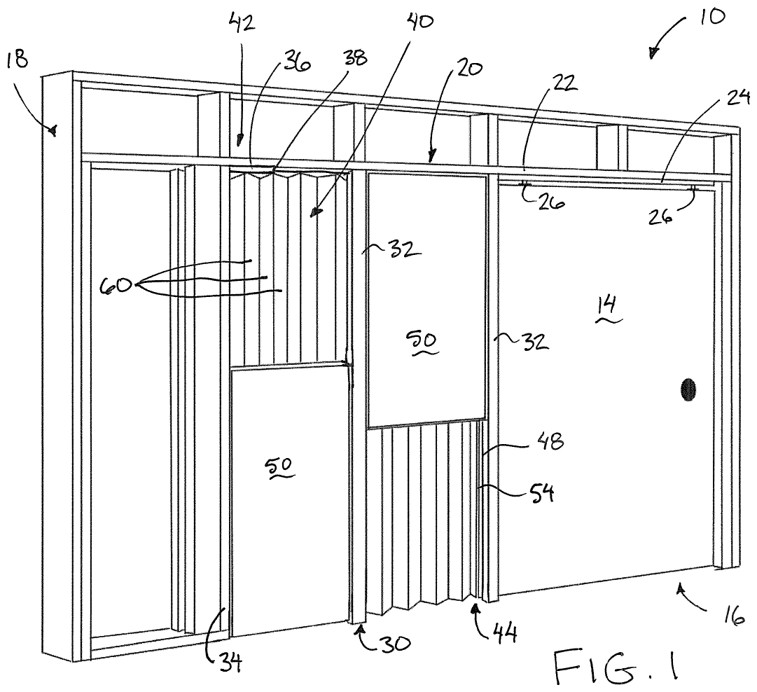

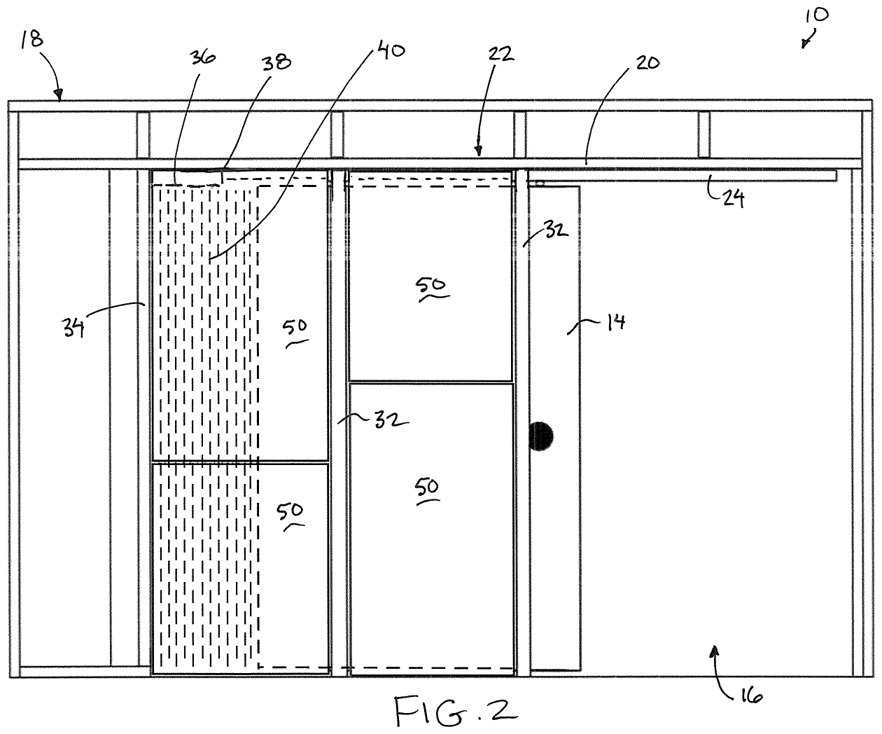

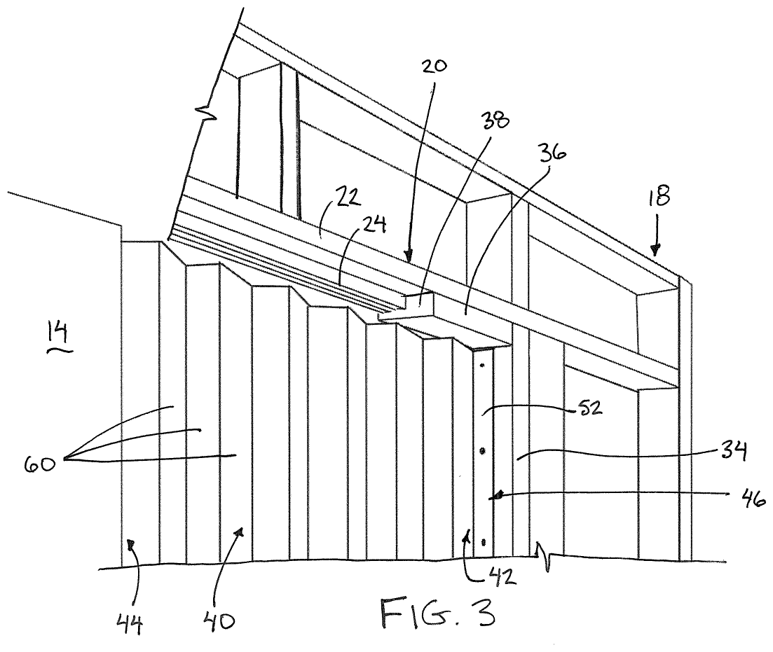

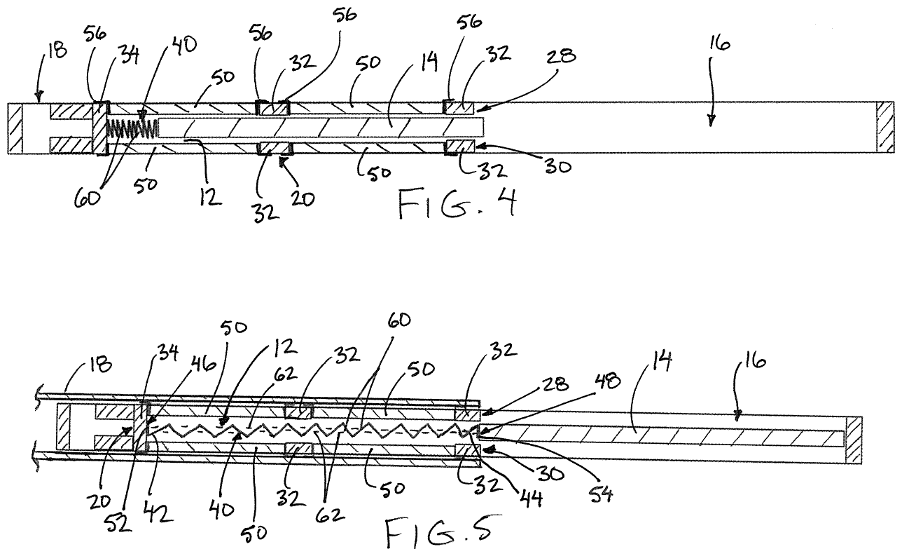

Turning now to the first embodiment illustrated in FIGS. 1 through 5, the collapsible sound attenuating structure 40 in this instance comprises a sheet of the sound attenuating material including a plurality of folds therein that span the full height of the sheet so as to define a plurality of accordion pleats 60, in which each plate is joined to one or more adjacent pleats by the respective flexible folds formed in the sheet. The width of each strip of material between adjacent folds defining one of the pleats is equal to or less than the thickness of the door pocket between the side frames so as to enable the pleats to be folded flat against one another in parallel arrangement to one another, perpendicularly to the longitudinal direction of the sliding door assembly, in the collapsed position of the structure 40. The stacked pleats 60 form a stack having an overall length in the longitudinal sliding direction which is equal to or less than the prescribed space defined by the stop member between the inner end of the door member and the inner terminal end of the door pocket in the open position of the door.

Optional additional strands 62 may be threaded through the pleats 60 or connected between adjacent pleats to assist in guiding extension and collapsing of the pleats relative to one another as the overall length of the collapsible structure is varied with opening and closing of the door. For example, the strands may comprise elastic material biasing the pleats into the collapsed position to maintain the pleats aligned with one another in the longitudinal direction. The strands 62 guide movement of the folding pleats to minimize engagement of the pleats with the inner side surfaces of the side frames or the panels 50 supported within the side frames to minimize wear of the sound attenuating material of the collapsible structure 40 with continued use.

In some embodiments, the inner surfaces of the side frames forming the opposing boundaries of the door pocket may include a continuous sheet of material having a low coefficient of friction to guide folding of the pleats from the extended position to the collapsed position while minimizing wear on the sound attenuating material of the collapsible structure 40.

In some instances, the individual strips forming each plate fixed the between adjacent folds of the sheet forming the structure 40 may comprise a stiff material that provides sound attenuation while the rigid strips are joined by flexible material at the folds so that the overall sheet remains flexible into the collapsed position by folding the rigid strips relative to one another.

The first and second mounting arrangements 46 and 48 in the first illustrated embodiment of FIGS. 1 through 5 merely comprise the outermost pleat or strip of material of the sheet material forming the sound attenuating structure 40 in which the strip can be secured directly to the inner stud 34 at the first end and the inner upright edge of the door member at the second end respectively.

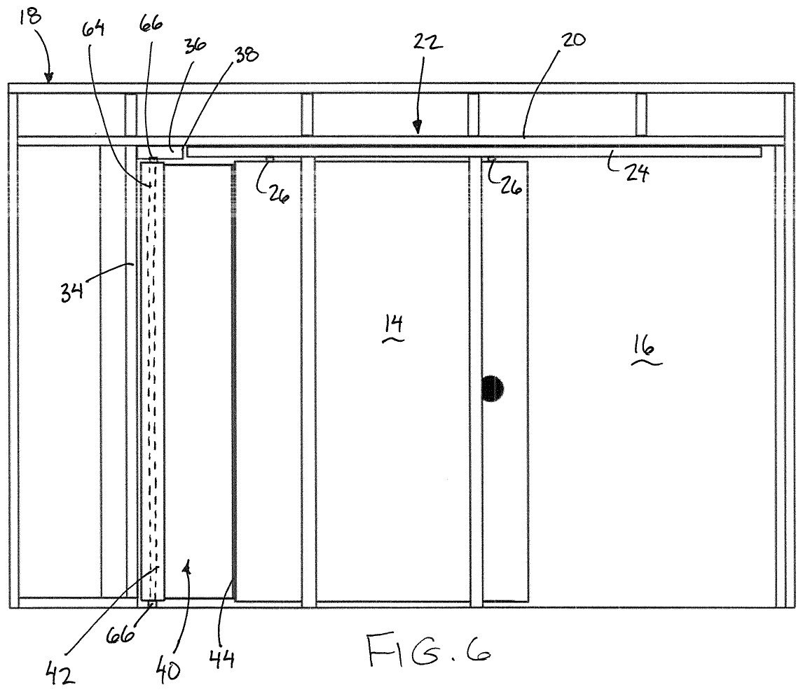

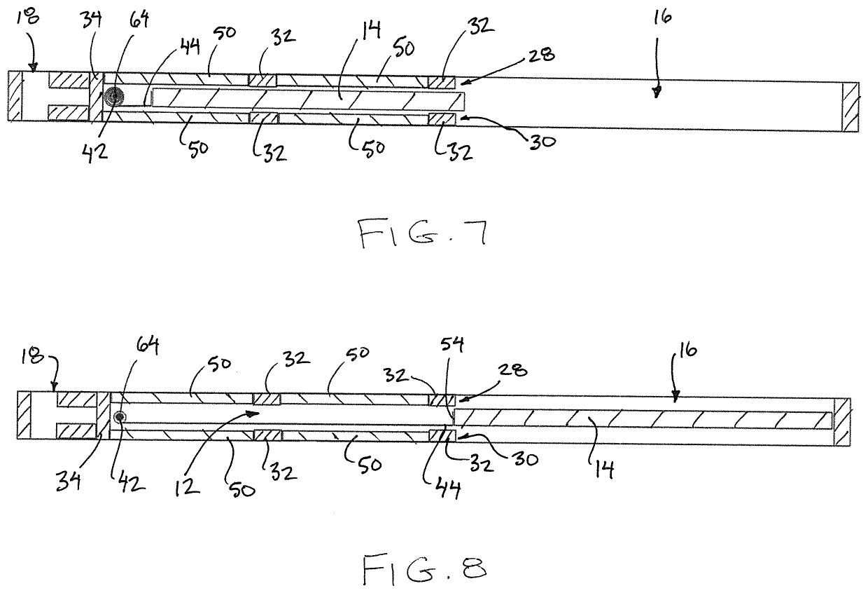

Turning now to the second embodiment shown in FIGS. 6 through 8, the sound attenuating structure 40 in this instance comprises a uniform flexible sheet arranged to span the full height and full length of the door pocket in the closed position of the sliding door member.

The second mounting arrangement in this instance again comprises a strip of material forming the collapsible structure 40 which spans the full height of the collapsible structure at the second end thereof, in which the strip of material can be secured to the inner upright edge of the sliding door by use of fasteners, adhesive, or mounting hardware as described above.

The first mounting arrangement in this instance further includes a roller 64 supported on respective brackets 66 at opposing top and bottom ends to mount the roller rotatably about a vertical rotation axis at a location immediately adjacent to the inner terminal end of the door pocket defined by the inner end stud 34. A strip of the flexible sheet at the first end thereof is secured along its full length to the roller to span substantially the full height of the door pocket. The first end of the sheet may be secured by space apart fasteners, adhesive, or various hardware which clamps or otherwise secures the first end of the flexible sheet along the length of the roller. One or more internal springs are operatively connected between the roller 64 and protruding shafts at both ends of the roller which are mounted on the respective brackets 66 to fix the shaft relative to the door frame. The one or more springs bias the roller 64 relative to the brackets 66 in a direction corresponding to rolling up of the flexible sheet onto the roller throughout the full range of movement of the sliding door member between the open and closed positions thereof such that the flexible sheet is maintained under tension between the roller and the second end of the flexible sheet secured to the sliding door member throughout the full range of movement of the sliding door member. The rolled up material on the roller 64 has an overall diameter in the open position of the sliding door which is equal to or less than the thickness of the door pocket in a direction perpendicular to the sliding door member and the longitudinal direction to ensure that the structure can be displaced into the collapsed position corresponding to the open position of the door without interference with the side frames or panels 50 on opposing sides of the door pocket respectively.

As described above, the pocket door sound attenuation system according to the preferred embodiment is a 2-part sound attenuating system that can be used with pocket doors or any other door that creates a cavity when closed. Part 1 of the system includes a collapsible material, whether it be accordion-style/retractable or other, which can unfold/unroll to fill a void left by a closed pocket door and fold up/roll up into a compact 4-to-8-inch device when the pocket door is open. In use, one side of the collapsible device is mechanically fastened to the vertical side of the door as well as the existing vertical wall framing said door opens to and butts against, thereby allowing the collapsible device to open within the wall as the pocket door is closed. Part 2 of the pocket door sound attenuation system consist of a stiff sound absorbing material manufactured with adhering flaps and/or mechanically fastened from vertical sides onto pocket door kit framing. The dimension of said material allows the pocket door to move freely as it normally would without interference or rubbing.

Since various modifications can be made in the invention as herein above described, and many apparently widely different embodiments of same made, it is intended that all matter contained in the accompanying specification shall be interpreted as illustrative only and not in a limiting sense.

1. A sound attenuation system for a sliding pocket door assembly operable relative to a door opening in a wall, the sliding pocket door assembly including (i) a sliding door member extending in a longitudinal direction between opposing upright side edges of the sliding door member, (ii) a track arranged to support the sliding door member thereon such that the sliding door member is slidable along the track in the longitudinal direction of the sliding door member relative to the door opening between a closed position spanning across the door opening and an open position in which the door opening is substantially unobstructed by the sliding door member, and (iii) a pocket door frame arranged to be mounted in the wall adjacent to the door opening and defining a door pocket therein for receiving the sliding door member in the open position of the sliding door member in which the pocket door frame includes first and second side frames extending longitudinally along opposing sides of the door pocket respectively to receive the sliding door member between the first and second side frames respectively, the sound attenuating system comprising:
a sound attenuating structure arranged to be supported within the door pocket to span a width of the door pocket in the longitudinal direction of the sliding pocket door assembly from a first end to a second end of the sound attenuating structure when the sliding door member is in the closed position in which the sound attenuating structure is formed of a sound absorbing material;
a first mounting arrangement arranged to secure the first end of the sound attenuating structure to an inner end of the door pocket farthest from the door opening;
a second mounting arrangement arranged to secure the second end of the sound attenuating structure to the sliding door member such that the second end of the sound attenuating structure is movable with the sliding door member between the open position and the closed position of the sliding door member;
wherein the sound attenuating structure is collapsible in length in the longitudinal direction of the sliding door member between the first mounting arrangement and the second mounting arrangement responsive to displacement of the sliding door member from the closed position to the open position.

2. The system according to claim 1 wherein the sound attenuating structure is collapsible to a collapsed position having a length in the longitudinal direction between the first end and the second end of sound attenuating structure that is sized to be received within the door pocket longitudinally end-to-end with the sliding door member in the open position of the sliding door member.

3. The system according to claim 2 wherein the sliding pocket door assembly comprises a stop member supported within the door pocket to prevent longitudinal displacement of the sliding door member away from the closed position beyond the open position, wherein the sliding door member within the door pocket in the open position is spaced from an inner terminal end of the door pocket towards the door opening at a prescribed distance, and wherein the length of the sound attenuating structure in the collapsed position is equal to or less than said prescribed distance.

4. The system according to claim 1 wherein the second mounting arrangement secures the second end of the sound attenuating structure to one of the upright side edges of the sliding door member that is received within the door pocket in the closed position of the sliding door member.

5. The system according to claim 1 further comprising at least one sound attenuating panel arranged to be fixedly supported on at least one of the side frames of the pocket door frame so as to receive the sliding door member in the door pocket alongside said at least one sound attenuating panel in the open position of the sliding door member.

6. The system according to claim 5 wherein said at least one sound attenuating panel comprises a rigid panel of sound attenuating material fully received within a boundary of said at least one of the side frames of the pocket door frame.

7. The system according to claim 5 wherein said at least one sound attenuating panel spans a full thickness of said at least one of the side frames of the pocket door frame in a direction perpendicular to the sliding door member.

8. The system according to claim 5 further comprising adhesive flaps mounted along one or more edges of said at least one sound attenuating panel so as to be arranged to adhesively secure said at least one sound attenuating panel to said at least one of the side frames of the pocket door frame.

9. The system according to claim 1 wherein the sound attenuating structure comprises a sheet having a plurality of accordion pleats formed therein such that the sound attenuating structure is arranged to be collapsed in the longitudinal direction by folding the according pleats.

10. The system according to claim 1 wherein one of the first mounting arrangement and the second mounting arrangement comprises a roller and wherein the sound attenuating structure comprises a flexible sheet mounted along one upright edge onto the roller such that the sound attenuating structure is arranged to be collapsed in the longitudinal direction by rolling up the sheet onto the roller, the roller being biased in a direction to roll up the sheet onto the roller.

11. A sliding pocket door assembly for operation relative to a door opening in a wall, the sliding pocket door assembly comprising:
a sliding door member extending in a longitudinal direction between opposing upright side edges of the sliding door member;
a track arranged to support the sliding door member thereon such that the sliding door member is slidable along the track in the longitudinal direction of the sliding door member relative to the door opening between a closed position spanning across the door opening and an open position in which the door opening is substantially unobstructed by the sliding door member;
a pocket door frame arranged to be mounted in the wall adjacent to the door opening and defining a door pocket therein for receiving the sliding door member in the open position of the sliding door member in which the pocket door frame includes first and second side frames extending longitudinally along opposing sides of the door pocket respectively to receive the sliding door member between the first and second side frames respectively;
a sound attenuating structure supported within the door pocket to span a width of the door pocket in the longitudinal direction of the sliding pocket door assembly from a first end to a second end of the sound attenuating structure when the sliding door member is in the closed position in which the sound attenuating structure is formed of a sound absorbing material;
a first mounting arrangement securing the first end of the sound attenuating structure to an inner end of the door pocket farthest from the door opening; and
a second mounting arrangement securing the second end of the sound attenuating structure to the sliding door member such that the second end of the sound attenuating structure is movable with the sliding door member between the open position and the closed position of the sliding door member;
wherein the sound attenuating structure is collapsible in length in the longitudinal direction of the sliding door member between the first mounting arrangement and the second mounting arrangement responsive to displacement of the sliding door member from the closed position to the open position.

12. The assembly according to claim 11 wherein the sound attenuating structure is collapsible to a collapsed position having a length in the longitudinal direction between the first end and the second end of sound attenuating structure that is sized to be received within the door pocket longitudinally end-to-end with the sliding door member in the open position of the sliding door member.

13. The assembly according to claim 12 wherein the sliding pocket door assembly comprises a stop member supported within the door pocket to engage one of the upright side edges of the sliding door member in the open position of the sliding door member in which the stop member is spaced from an inner terminal end of the door pocket towards the door opening at a prescribed distance, and wherein the length of the sound attenuating structure in the collapsed position is equal to or less than said prescribed distance.

14. The assembly according to claim 11 wherein the second mounting arrangement secures the second end of the sound attenuating structure to one of the upright side edges of the sliding door member that is received within the door pocket in the closed position of the sliding door member.

15. The assembly according to claim 11 further comprising at least one sound attenuating panel arranged to be fixedly supported on at least one of the side frames of the pocket door frame so as to receive the sliding door member in the door pocket alongside said at least one sound attenuating panel in the open position of the sliding door member.

16. The assembly according to claim 15 wherein said at least one sound attenuating panel comprises a rigid panel of sound attenuating material fully received within a boundary of said at least one of the side frames of the pocket door frame.

17. The assembly according to claim 15 wherein said at least one sound attenuating panel spans a full thickness of said at least one of the side frames of the pocket door frame in a direction perpendicular to the sliding door member.

18. The assembly according to claim 15 further comprising adhesive flaps mounted along one or more edges of said at least one sound attenuating panel so as to be arranged to adhesively secure the sound attenuating panel to said at least one of the side frames of the pocket door frame.

19. The assembly according to claim 11 wherein the sound attenuating structure comprises a sheet having a plurality of accordion pleats formed therein such that the sound attenuating structure is arranged to be collapsed in the longitudinal direction by folding the according pleats.

20. The assembly according to claim 11 wherein one of the first mounting arrangement and the second mounting arrangement comprises a roller and wherein the sound attenuating structure comprises a flexible sheet mounted along one upright edge onto the roller such that the sound attenuating structure is arranged to be collapsed in the longitudinal direction by rolling up the sheet onto the roller, the roller being biased in a direction to roll up the sheet onto the roller.
